(19) United States
(12) Patent Application Publication
(10) Pub. No.: US 2011/0103063 A1
(43) Pub. Date: May 5, 2011

(54) OPTICS FOR AN AUTOMATED LUMINAIRE

(75) Inventor: Pavel Jurik, Postredni Becva (CZ)

(73) Assignee: ROBE LIGHTING S.R.O

(21) Appl. No.: 12/880,076

(22) Filed: Sep. 11, 2010

Related U.S. Application Data
(60) Provisional application No. 61/241,882, filed on Sep. 12, 2009.

(51) Int. Cl. F21V 19/02

(52) U.S. Cl. 362/285

(57) ABSTRACT

Described are an improved automated luminaire and luminaire systems employing an improved articulated output lens focus system.

### TECHNICAL FIELD OF THE INVENTION

The present invention generally relates to an automated luminaire, specifically to an optical system for use within an automated luminaire.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will commonly provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern.

FIG. 1 illustrates a multiparameter automated luminaire system 10. These systems commonly include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. The luminaire system 10 is typically controlled by an operator through the control desk 15.

FIG. 2 illustrates a prior art automated luminaire 12. A lamp 21 contains a light source 22 which emits light. The light is reflected and controlled by reflector 20 through optical devices 26 which may include dichroic color filters, effects glass and other optical devices well known in the art and then through an aperture or imaging gate 24. Optical components 27 are the imaging components and may include gobos, rotating gobos, iris and framing shutters. The final output beam may be transmitted through output lens 31. Lens 31 may be a short focal length glass lens or equivalent Fresnel lens as described herein. Either optical components 27 or lens 31 may be moved backwards and forwards along the optical axis to provide focus adjustment for the imaging components.

There is a need for an improved lens system for an automated luminaire which provides easy and rapid focus adjustment without compromising the automated movement of the automated luminaire.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates a prior art automated luminaire;

FIG. 3 illustrates an automated luminaire with an improved optical focus system;

FIG. 4 illustrates an exploded view some of the components of the embodiment illustrated in FIG. 3;

FIG. 5 illustrates one position of the Fresnel lens in the improved focus optical system embodiment of FIG. 3;

FIG. 6 illustrates a second position of the Fresnel lens in FIG. 5;

FIG. 7 illustrates the a perspective view of the Fresnel lens; and

FIG. 8 illustrates two different Fresnel lenses.

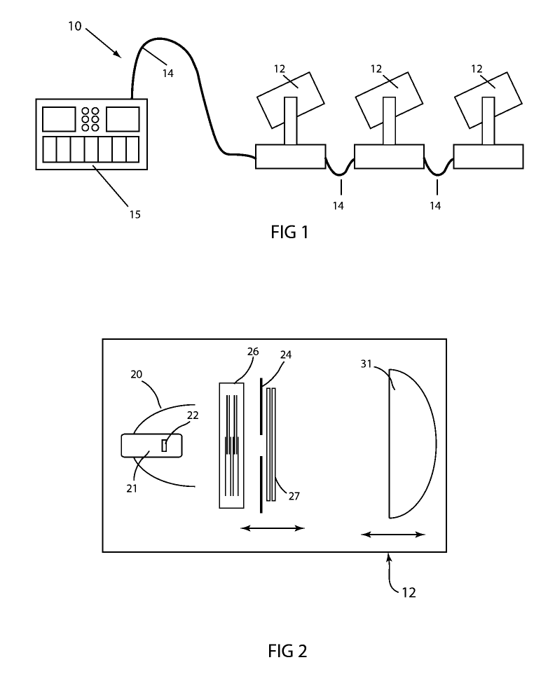

### DETAILED DESCRIPTION OF THE INVENTION

Preferred embodiments of the present invention are illustrated in the FIGUREs, like numerals being used to refer to like and corresponding parts of the various drawings.

The present invention generally relates to an automated luminaire, specifically to the configuration of an output lens within such a luminaire such that the lens provides sharply focused images and is movable to provide focus adjustment while being light weight so that it may be moved easily and rapidly and any changes to the center of gravity of the luminaire are minimized.

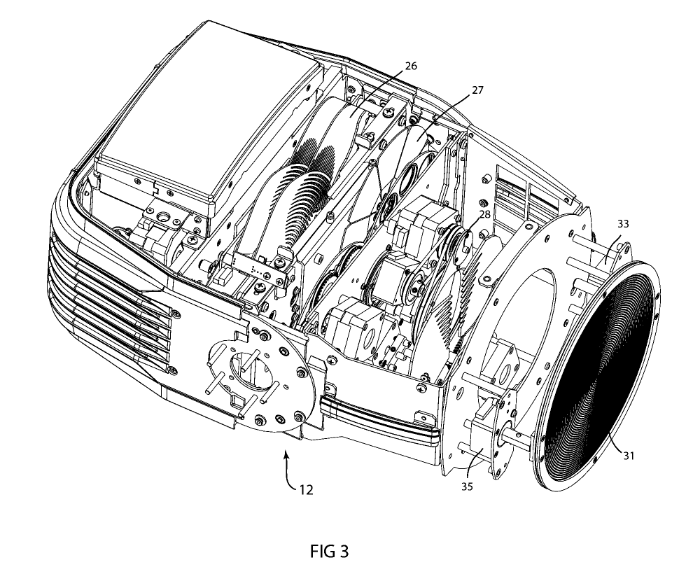

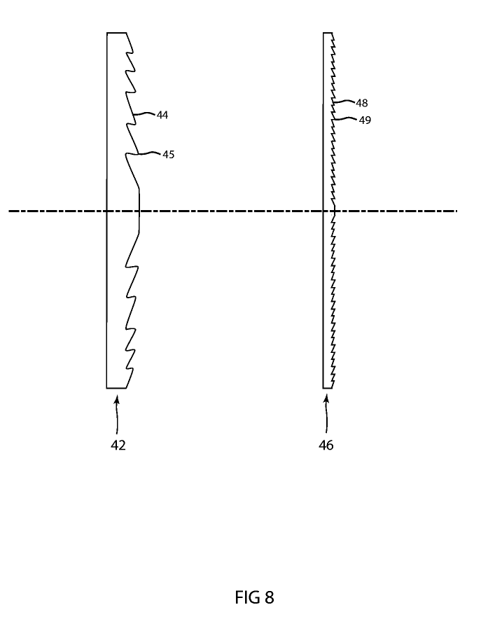

FIG. 3 illustrates an embodiment of the invention. Automated luminaire 12 contains imaging optical components 27 which may include but are not limited to gobos, rotating gobos, shutters and iris. The light beam from these images is focused by output lens 31. In the illustrated embodiment the output lens 31 incorporates an improved Fresnel lens. Output lens 31 may be a Fresnel lens as shown in FIG. 7 and FIGS. 8 (31 and 46 respectively) Where a typical prior art Fresnel lens (42 in FIG. 8) typically comprise 10-15 circumferential facets for a 150 mm diameter lens, the Fresnel lens 31 in the embodiment illustrated in FIG. 3 has at least twice, or more, the number of circumferential facets. This substantial increase in the number of circumferential facets serves to significantly improve the optical resolution of the lens and thus provide a sharper output image. In one embodiment, the Fresnel lens has approximately 100 circumferential facets.

Further improvement is provided by the shape of the facets. A typical prior art Fresnel lens is manufactured of glass and suffers from surface tension effects during molding such that the tips 45 of each facet 44 are rounded to a large radius. This radius causes scattering of the transmitted light and thus softens the projected image. In the embodiment illustrated in FIG. 3, the Fresnel lens is manufactured of a plastic or polymer through a molding process that provides significantly reduced radius of curvature on the pointed tips 49 of the facet 48. This smaller radius of curvature significantly reduces light scattering from these tips and thus provides enhanced sharpness in the projected image.

The choice of material as a polymer or plastic further serves to reduce the weight of lens 31. Lens 31 may be moved backwards and forwards along the optical axis of the luminaire so as to provide focus adjustment of the projected images of desired optical element(s) 27. In one embodiment of the invention motors 33 and 35 may provide the movement of output lens 31 through lead screw drives 34 and 36. Motors 33 and 35 may be low power stepper motors.

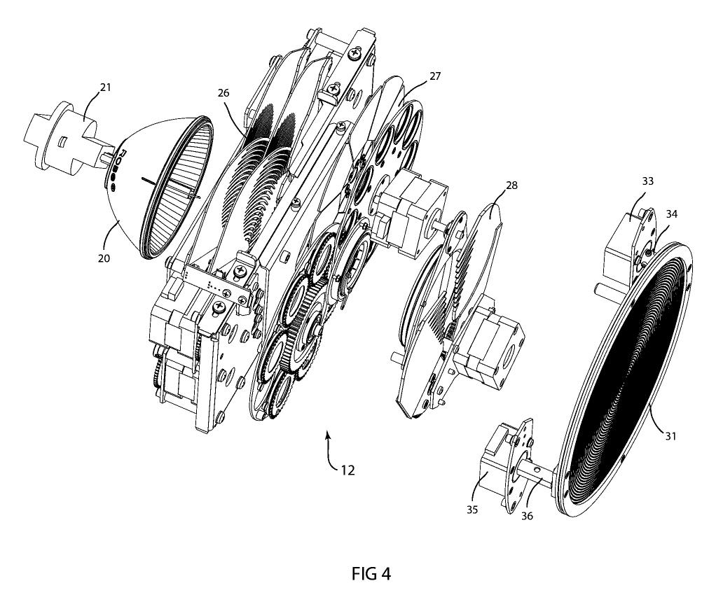

FIG. 4 illustrates an exploded view of an embodiment of the invention. Motors 33 and 35 provide movement of output lens 31 along the optical axis through lead screw drives 34 and 36. Movement of output lens 31 serves to provide focus adjustment of the projected images of desired optical element(s) 27.

In one embodiment of the invention motors 33 and 35 may provide the movement of output lens 31 through lead screw drives 34 and 36. Motors 33 and 35 may be relatively low power stepper motors.

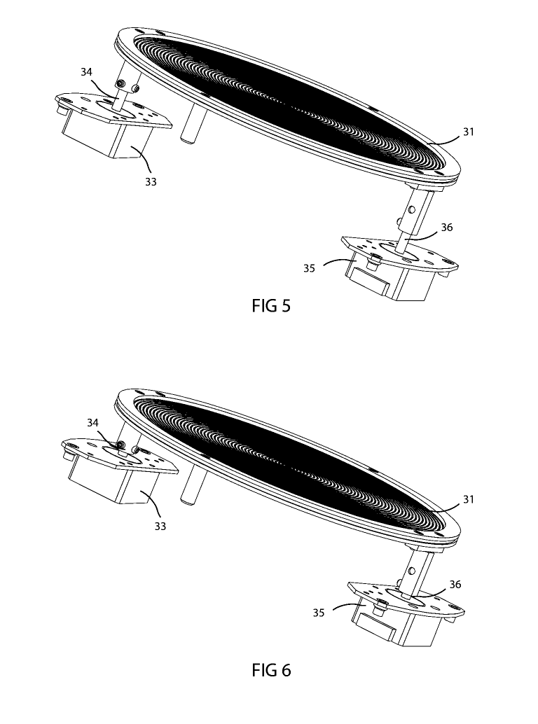

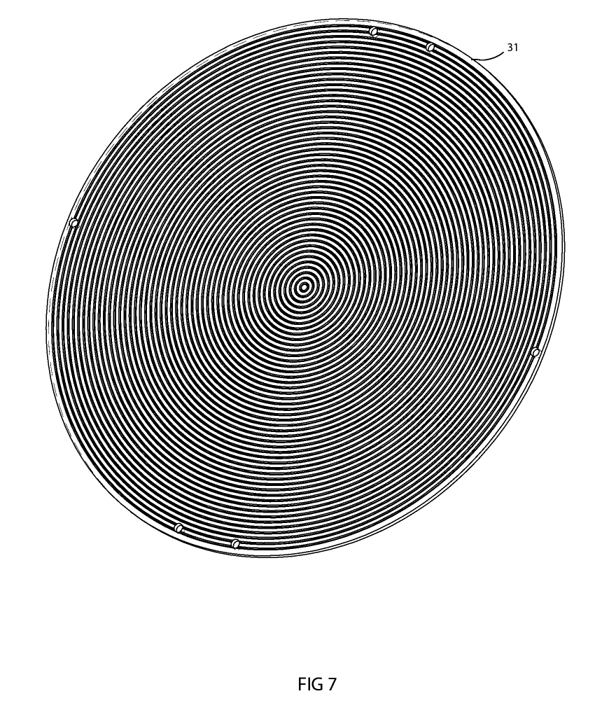

FIG. 5 and FIG. 6 illustrate the movement of lens 31 along the optical axis of the luminaire. In one embodiment of the invention lens 31 is positioned by lead screws 34 and 36 connected to motors 33 and 35. Rotation of motors 33 and 35 causes rotation of lead screws 34 and 36 and thus translation of lens 31. FIG. 5 shows Fresnel lens 31 in a first position and FIG. 6 shows Fresnel lens 31 in a second position. Although lead screws 34 and 36 are illustrated as the means for translating rotary motion of motors 33 and 35 into the linear motion of lens 31 the invention is not so limited and lens 31 may be moved along the optical axis using belt drives, rack and pinion drive, linear actuators or any other method of driven linear motion known in the art. Lens 31 is a thin, lightweight polymer Fresnel lens such that motors 33 and 35 may be relatively small, low powered motors of type selected from but not limited to stepper motors, servo motors, linear actuators or low powered DC motors.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

We claim:

1. A imaging automated luminaire employing a thin lightweight polymer Fresnel lens with large number of sharp tip facets wherein the Fresnel lens is articulatable along the optical axis whereby the focus of the image can be adjusted while the balance/movement of the luminaire is not compromised by adjustment of the focus of the luminaire.
